(19) United States
(12) Patent Application Publication
(10) Pub. No.: US 2014/0164805 A1
(43) Pub. Date: Jun. 12, 2014

(54) DATA PROCESSING APPARATUS, METHOD FOR CONTROLLING DATA PROCESSING APPARATUS, AND PROGRAM

(71) Applicant: CANON KABUSHIKI KAISHA, Tokyo (JP)

(72) Inventor: Shigeki Hasui, Tokyo (JP)

(73) Assignee: CANON KABUSHIKI KAISHA, Tokyo (JP)

(21) Appl. No.: 14/095,334

(22) Filed: Dec. 3, 2013

(30) Foreign Application Priority Data
Dec. 6, 2012 (JP) 2012-266915

(51) Int. Cl. G06F 1/32; G06F 1/26

(52) U.S. Cl. CPC G06F 1/325; G06F 1/266
USPC 713/323

(57) ABSTRACT

A data processing apparatus operating in a first power mode and a second power mode in which power consumption is lower than that of the first power mode includes a plurality of USB interfaces, a selection unit configured to select at least one of the USB interfaces which is to be used when the second power mode is entered, and a control unit configured to perform control so that, in the second power mode, electric power is supplied to a device connected to the at least one of the USB interfaces selected by the selection unit through the at least one of the USB interfaces.

### BACKGROUND OF THE INVENTION

1. Field of the Invention

One disclosed aspect of the embodiments relates to power saving control of a data processing apparatus which may enter a power saving state, a method for controlling the data processing apparatus, and a program.

2. Description of the Related Art

In recent years, power saving techniques which realize reduction of power consumption of general electric products such as home electric appliances and office equipment have been in high demand due to being environmentally friendly. Data processing apparatuses such as multifunction apparatuses (including multifunction printers) which have a document scanning function and a printing function and which further have a function of performing advanced information processing while communicating with external apparatuses have been used. In general, as a power saving technique for such a data processing apparatus, a technique of reducing electric power at a time of a standby state of an apparatus by automatically entering a power saving state when the apparatus is not operated for a predetermined period of time is in practical use.

With the progress in the power saving capability of multifunction apparatuses, functional enhancement of multifunction apparatuses has also been progressing for the purpose of improving user-friendliness, and examples of the enhanced function include a function enabling connection to an external device. In the function of connecting to an external device, extension of the function may be attained by connecting a peripheral device through an external interface such as a universal serial bus (USB) included in such a multifunction apparatus. The USB interface enables data communication between devices and also enables supply of electric power (at most 500 mA in 5 V in the standard of USB 2.0), and peripheral devices of the electric power standard may be connected to USB interfaces and driven without an external power supply. Furthermore, the USB interfaces may be attached to and detached from the multifunction apparatus which is powered (hot swap) and enables the number of peripheral devices to be increased or decreased with ease. Examples of the peripheral devices connected to the multifunction apparatus through the USB interfaces include an authentication card reader and a keyboard. Such peripheral devices may provide, in addition to a function unique to the peripheral devices such as an authentication function and a text input function, a return factor which is a trigger which prompts transfer from a power saving state to a normal operation state.

Here, a case where a plurality of peripheral devices having return factors are connected to a data processing apparatus through USB interfaces and a power saving state is entered is taken as an example. In this case, there arises a problem in that, when the peripheral devices are activated and a plurality of return factors are to be detected, electric power is required to be supplied to a number of USB interfaces corresponding to a number of connections even in a power saving state, and power consumption is increased due to the power supply.

In order to address the above-described problem, that is, in order to attain saving of electric power supplied for the plurality of return factors in the power saving state, in Japanese Patent Laid-Open No. 2010-218120, a technique of not supplying electric power to devices corresponding to unused return factors among a plurality of return factors in a power saving state is proposed.

The technique disclosed in Japanese Patent Laid-Open No. 2010-218120 includes a plurality of return factor detection units and a selection unit which selects enabling or disabling of at least one of the return factor detection units. By this, when the power saving state is entered, power saving is realized by performing control such that electric power is not supplied to a peripheral device in which a return factor is set to be disabled by the selection unit.

However, when the technique disclosed in Japanese Patent Laid-Open No. 2010-218120 is applied to a peripheral device including a USB interface, the following problems may occur.

First, if a determination as to whether a dynamically-connected device corresponds to a return factor cannot be made, a determination as to whether a return factor is valid or invalid also cannot be made. As described above, since the USB interface is available for the hot swap, a result of the determination as to whether a connected device corresponds to a return factor is not fixed but the result is flexible.

Second, if electric power is supplied to all devices connected through USB interfaces in the power saving state, a power supply controller may have an excessive load and failure of the devices may occur due to supply of electric power which exceeds a power supply capacity. Multifunction apparatuses consume a comparatively large amount of power (1000 W or more, for example) in a normal operation state. Therefore, in a power saving state, a small power source unit which is different from a power source unit of a large capacity used in the normal operation state is used so that power efficiency is enhanced in the power saving state and a total amount of power supply is considerably limited in the power saving state (10 W or less, for example). In order not to exceed the total amount of power supply in the power saving state, power supply control is performed such that the power consumptions of dynamically-connected devices are recognized and an amount of the power consumptions is within the total amount of power supply.

Third, in an environment in which a plurality of users use a multifunction apparatus, it is likely that the users use the apparatus in various ways and various return methods are used. Accordingly, if a method of return from a power saving state is fixedly set, usability may be degraded. In order to attain excellent usability and power saving, return factors are set valid in accordance with use frequency of the users.

### SUMMARY OF THE INVENTION

One disclosed aspect of the embodiments provides a system in which, after a power saving mode is entered, a peripheral device having high priority of detection of a return factor is specified and electric power is supplied to the peripheral device so as not to exceed the amount of available electric power.

A data processing apparatus according to one embodiment which addresses the problem has a configuration described below.

A data processing apparatus operating in a first power mode and a second power mode in which power consumption is lower than that of the first power mode includes a plurality of USB interfaces, a selection unit configured to select at least one of the USB interfaces which is to be used when the second power mode is entered, and a control unit configured to perform control so that, in the second power mode, electric power is supplied to a device connected to the at least one of the USB interfaces selected by the selection unit through the selected at least one of the USB interfaces. Electric power is not supplied from the data processing apparatus to devices connected to the USB interfaces which are not selected by the selection unit.

Further features of the disclosure will become apparent from the following description of exemplary embodiments with reference to the attached drawings.

### BRIEF DESCRIPTION OF THE DRAWINGS

FIG. 1 is a block diagram illustrating a configuration of an image processing system employing a data processing apparatus.

FIG. 2 is a block diagram illustrating a configuration of the data processing apparatus illustrated in FIG. 1 in detail.

FIG. 3 is a flowchart illustrating a method for controlling the data processing apparatus.

FIG. 4 is a diagram illustrating an exemplary electric power upper limit table managed by the data processing apparatus.

FIG. 5 is a diagram illustrating an exemplary USB device management table which manages USB devices.

FIGS. 6A and 6B are a flowchart illustrating a method for controlling the data processing apparatus.

FIGS. 7A, 7B, and 7C are diagrams illustrating exemplary UI screens displayed in an operation unit illustrated in FIG. 1.

### DESCRIPTION OF THE EMBODIMENTS

Next, embodiments of the disclosure will be described in detail with reference to the accompanying drawings. Note that portions having the same functions are denoted by the same reference numerals in the drawings, and redundant description is omitted where appropriate.

### System Configuration

### First Embodiment

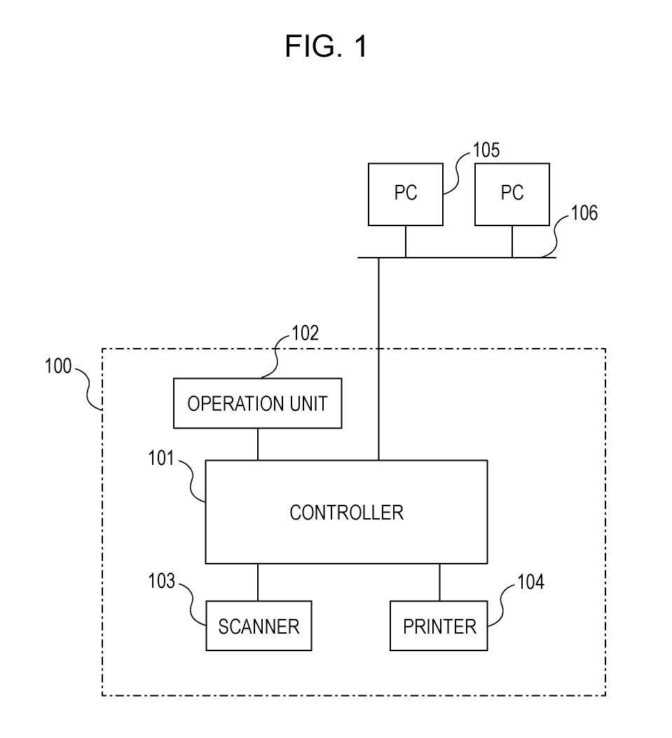

FIG. 1 is a block diagram illustrating a configuration of an image processing system employing a data processing apparatus according to a first embodiment. In this embodiment, a case where a multifunction apparatus which executes a multiple function process described above is used as an example of a data processing apparatus is described. However, the disclosure is applicable to a printer apparatus having a single function or the like. Note that, in this embodiment, a data processing apparatus having a power saving function of operating in a normal operation mode (first power mode) and a power saving mode (second power mode) in which power supply is limited is taken as an example.

In FIG. 1, a data processing apparatus 100 is a multifunction apparatus which performs input and output of images, transmission and reception of images, and various image processes. The data processing apparatus 100 includes a main controller 101, an operation unit 102 serving as a user interface, a scanner 103 serving as an image input device, and a printer 104 serving as an image output device. The operation unit 102, the scanner 103, and the printer 104 are connected to the main controller 101 which controls operations of the units. The main controller 101 is further connected to a host PC 105 through various external interfaces included in the data processing apparatus. Examples of the external interfaces include a local area network (LAN) 106.

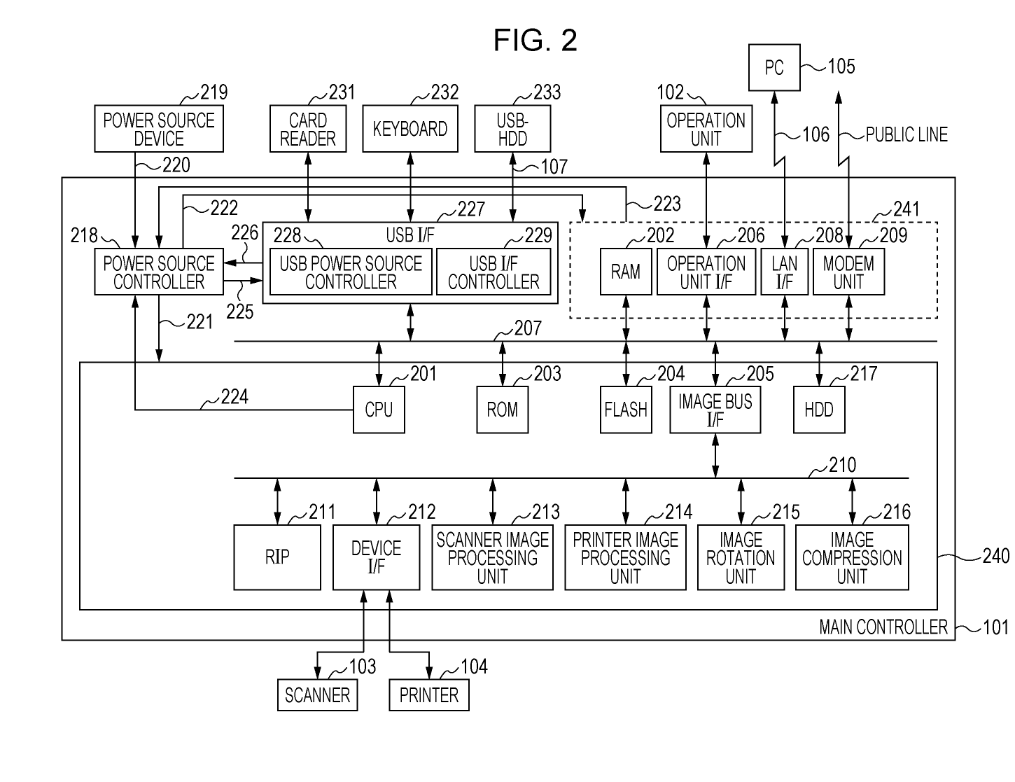

FIG. 2 is a block diagram illustrating a configuration of the data processing apparatus 100 illustrated in FIG. 1 in detail. Note that the data processing apparatus 100 of this embodiment includes the main controller 101 which controls the entire apparatus.

In FIG. 2, the main controller 101 controls the scanner 103 and the printer 104 which are connected to the main controller 101. Furthermore, the main controller 101 is connected to the LAN 106 and a public line and performs communication with external apparatuses so as to perform input and output of various information including image information and device information through the LAN 106 and a USB 107.

The main controller 101 includes a central processing unit (CPU) 201 which performs main control. The CPU 201 is connected through a system bus 207 to a random-access memory (RAM) 202, a read only memory (ROM) 203, a flash memory 204, an image bus I/F 205, an operation unit I/F 206, a LAN I/F 208, and a modem unit 209.

The RAM 202 is a memory serving as a work area of the CPU 201 and is readable and writable where appropriate. The RAM 202 is also used as an image memory which temporarily stores image data. The ROM 203 is a boot ROM which stores a boot program of the system. The flash memory 204 is a nonvolatile memory which stores system software, setting value data, and the like which are maintained after the data processing apparatus 100 is powered off.

The operation unit I/F 206 is an interface used to perform input and output between the main controller 101 and the operation unit 102 including a liquid crystal touch panel. The operation unit I/F 206 is used to output image data to be displayed to the operation unit 102 and transmit information input by a user through the operation unit 102 to the CPU 201.

The LAN I/F 208 which is an interface connected to the LAN 106 and which is used for communication with the LAN 106 input information from and output information to the LAN 106. The modem unit 209 which is an interface used for connection to the public line input information from and outputs information to the public line.

The image bus I/F 205 which is an interface used to connect the system bus 207 to an image bus 210 which transfers image data at high speed functions as a bus bridge which converts a data structure.

A raster image processor (RIP) 211, a device I/F 212, a scanner image processing unit 213, a printer image processing unit 214, an image rotation unit 215, and an image compression unit 216 are connected to the image bus 210.

The RIP 211 converts page description language (PDL) data supplied from the LAN 106 into a bitmap image. The device I/F 212 is an interface which connects the main controller 101 to the scanner 103 and the printer 104 and performs synchronous/synchronous conversion on image data. The scanner image processing unit 213 performs processes including correcting, modifying, and editing on input image data read from the scanner 103. The printer image processing unit 214 performs processes including color conversion, filter processing, and resolution conversion on print-output image data to be output to the printer 104. The image rotation unit 215 performs rotation of image data. The image compression unit 216 performs a JPEG compression/decompression process on multi-valued image data and performs a JBIG compression/decompression process, an MMR compression/decompression process, or an MH compression/decompression process on binary image data.

A hard disk (HDD) 217 which is a nonvolatile data storage device stores various data including image data, address book data, a job log, and data unique to a user. In a case where the main controller 101 does not include the HDD 217, the various data is stored in the flash memory 204.

A power source controller 218 supplies DC electric power which is received from a power source device 219 serving as a power supply unit through a power supply line 220 to certain circuit elements of the main controller 101 through power supply lines 221, 222, and 225. Furthermore, the power source device 219 includes two power source circuit systems, that is, a large power source circuit for supplying a large amount of power, not illustrated, and a small power source circuit for supplying a small amount of power, not illustrated. The power source controller 218 performs changeover between the power source circuits in accordance with the power state of the data processing apparatus 100 which will be described hereinafter.

Furthermore, the power source controller 218 receives signals through a return control line 223 connected to the operation unit I/F 206, the LAN I/F 208, and the modem unit 209, a control signal line 224 connected to the CPU 201, and a return control line 226 connected to a USB I/F 227. Then the power source controller 218 performs power supply control of the power supply lines 221, 222, and 225 in accordance with the received control signals.

The power supply line 221 is connected to the CPU 201, the ROM 203, the HDD 217, and the image bus I/F 205. Furthermore, the power supply line 221 is connected to the RIP 211, the device I/F 212, the scanner image processing unit 213, the printer image processing unit 214, the image rotation unit 215, and the image compression unit 216. The power supply line 222 is connected to the RAM 202, the operation unit I/F 206, the LAN I/F 208, and the modem unit 209.

The power supply line 225 is connected to the USB I/F 227.

The USB I/F 227 (USB interface) is connected to various peripheral devices (hereinafter referred to as “USB devices”) having the USB for communication. The USB I/F 227 includes a USB power source controller 228 and a USB I/F controller 229, electrically connects the main controller 101 to USB devices connected to the USB I/F 227, and performs input/output control on information and power source control. Note that a case where the USB interface conforms to the USB 3.0 standard will be described as an example.

In this embodiment, three USB ports are provided, that is, at most three USB devices may be connected. The USB power source controller 228 and the USB I/F controller 229 perform connection control and power supply control on a port-by-port basis. Note that, in this embodiment, during transfer to a power saving mode, electric power is supplied from the USB power source controller 228 to peripheral devices which have a high priority for supply of electric power and which are specified by control described below within a range in which a power supply limit value is not exceeded (7 W (a setting value which is changeable) described below). Furthermore, the peripheral devices function as devices which detect a return request for returning to the normal operation mode from the power saving mode.

A card reader 231, a keyboard 232, and a USB-HDD 233 which are USB devices are connected to the main controller 101 through the USB I/F 227 included in the main controller 101. The USB power source controller 228 supplies electric power to the USB devices in accordance with electric power supplied from the power source device 219 and the power source controller 218 through the power supply line 225. Each of the USB devices has ID information (a USB class ID, a vendor ID, and a product ID) described below in advance. Each of the USB devices has unique ID information and each of the USB devices connected to the main controller 101 may be identified by the ID information. The USB devices (the card reader 231, the keyboard 232, and the USB-HDD 233) in this embodiment are not limited to these devices and other USB devices may be connected.

The data processing apparatus 100 has, as power supply states, a normal operation state and a power saving state in which power consumption is lower than that of the normal operation state.

In the normal operation state, the power source device 219 supplies electric power to the power source controller 218 through the power supply line 220 while the two power source circuit systems, that is, the large power source circuit and the small power source circuit, are set to be available. Furthermore, the CPU 201 controls the power source controller 218 so that power supply to the power supply lines 221, 222, and 225 becomes available. Here, the power source controller 218 controls the power supply lines 221 and 225 so that the power supply using the large power source circuit of the power source device 219 becomes available and controls the power supply line 222 so that the power supply using the small power source circuit of the power source device 219 becomes available.

In the normal operation state, when an operation request is not issued by a user for a predetermined period of time or when a user presses a switch, not illustrated, included in the operation unit 102, the data processing apparatus 100 transfers from the normal operation state to the power saving state.

In the power saving state, the power source device 219 supplies electric power to the power source controller 218 through the power supply line 220 while only the small power source circuit is made available. Furthermore, the CPU 201 controls the power source controller 218 so that the power supply to the power supply lines 222 and 225 becomes available and the power supply to the power supply line 221 becomes unavailable. Here, power supply to a normal-operation circuit element 240 which includes the image bus 210 and which is included in the main controller 101 is blocked. As a result, in the power saving state, when compared with the normal operation mode, power consumption of the data processing apparatus 100 may be reduced by at least an amount equal to the electric power to be used by the normal-operation circuit element 240.

On the other hand, even in the power saving state, electric power is supplied to a power-saving circuit element 241 including the operation unit I/F 206 and the LAN I/F 208 and the USB I/F 227. Therefore, a factor causing a return to the normal operation mode, such as pressing of a switch, not illustrated, included in the operation unit 102 performed by the user or reception of data such as a print job from the PC 105 connected to the LAN 106 may be detected by the operation unit I/F 206 or the LAN I/F 208.

Then a notification representing return control is transmitted to the power source controller 218 through the return control signal line 223 so that return from the power saving state to the normal operation state is realized. Similarly, in the USB I/F 227, the USB I/F controller 229 detects reception of a return factor from one of the USB devices (the card reader 231, the keyboard 232, and the USB-HDD 233), and transmits a notification representing return control to the power source controller 218 through the return control line 226 so that return to the normal state is realized.

In the power saving state, the power source device 219 also supplies electric power to the RAM 202. Therefore, the RAM 202 performs backup of a system program by a self-refresh operation, and return of a system state is quickly performed after the return from the power saving state to the normal operation state is performed.

This embodiment is characterized in that electric power is not required to be supplied from the USB I/F 227 to all the USB devices and is supplied to at least one of the USB devices selected in accordance with power consumption values of the USB devices and the numbers of times the devices are used by the user for return so that power saving and user-friendliness are both attained. Hereinafter, a method for supplying electric power to the USB devices when the data processing apparatus 100 is in the power saving state according to this embodiment will be described.

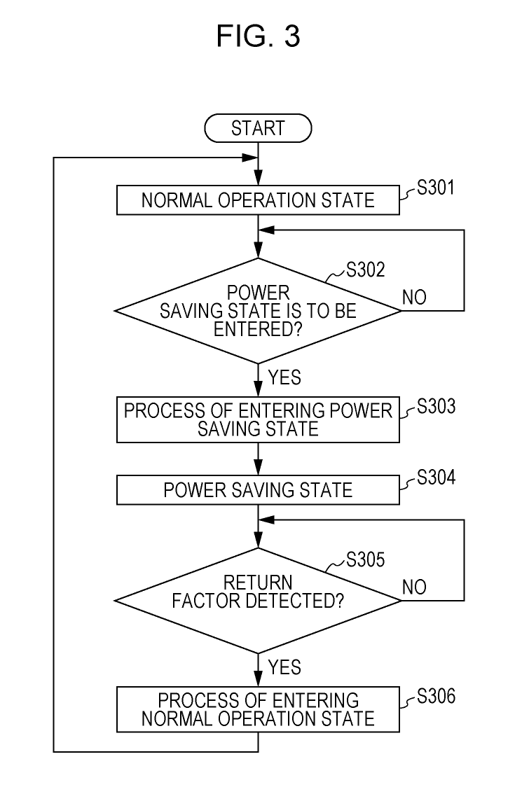

FIG. 3 is a flowchart illustrating a method for controlling the data processing apparatus 100 of this embodiment. Hereinafter, a flow of processing performed by the main controller 101 when the data processing apparatus 100 illustrated in FIG. 1 transfers from the normal operation state to the power saving state and returns from the power saving state to the normal operation state will be described. Here, a process depicted in a flowchart illustrated in FIG. 3 is started when the data processing apparatus 100 is powered and the CPU 201 detects the end of an activation process, not illustrated. Furthermore, the process is realized when the CPU 201 executes control programs stored in the ROM 203 or the like so as to control the other circuit elements included in the main controller 101 so that the circuit elements operate in cooperation with one another unless otherwise noted.

First, the CPU 201 controls the circuit elements included in the main controller 101 so that the data processing apparatus 100 enters the normal operation state (S301). Here, the power source device 219 enables the two power source circuit systems, that is, the large power source circuit and the small power source circuit, not illustrated. Furthermore, the power source controller 218 supplies electric power to the power supply lines 221 and 225 from the large power source circuit and to the power supply line 222 from the small power source circuit. Since the electric power is supplied from the large power source circuit to the USB I/F 227, the total amount of electric power to be supplied to the USB devices is sufficiently large (1000 W or more, for example). Therefore, electric power may be supplied to the USB devices irrespective of the power consumption of the USB devices.

Next, a determination as to whether the power saving state is to be entered from the normal operation state is made (S302).

As the determination as to whether the power saving state is to be entered, it is determined whether a waiting time for transfer to the power saving state which is set in advance has expired, for example. The determination as to whether the transfer waiting time has expired is made by counting to a set time using a timer, not illustrated, included in the main controller 101. When the transfer waiting time has expired, a power saving state transfer process is entered (S303). As another determination as to whether the power saving state is to be entered, it is determined whether the user has pressed a switch, not illustrated, included in the operation unit 102. It is determined that the switch has been pressed when the CPU 201 detects a press notification signal transmitted from the operation unit 102 to the operation unit I/F 206. When the switch is pressed, the power saving state transfer process (S303) is performed whereas when the switch is not pressed, the process in step S302 is performed so that the determination as to whether the power saving state is to be entered is made again. The power saving state transfer determination described above is not limited to these methods and the determination order may be reversed or only one of the determination methods may be used.

When the transfer from the normal operation state to the power saving state is determined to be performed, various processes of the power saving state transfer process are performed (S303). For example, the CPU 201 controls the power source device 219 so that the large power source circuit becomes unavailable and only the small power source circuit becomes available.

Furthermore, the power source controller 218 performs control so that power supply to the power supply line 221 becomes unavailable, and electric power is supplied to the USB I/F 227 through the power supply line 225 from the small power source circuit instead of the large power source circuit. In addition, the power source controller 218 performs control so that states of various processes executed by the CPU 201 in the normal operation state and setting states of the circuit elements included in the main controller 101 are saved in the RAM 202, and thereafter, causes the RAM 202 to perform a self-refresh operation. The power saving state transfer process performed by the USB I/F 227 will be described in detail hereinafter.

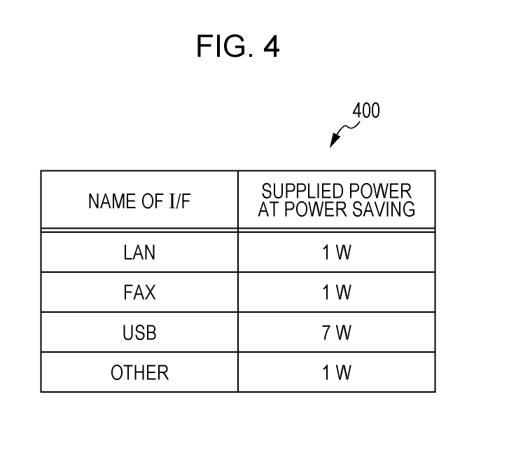

In the power saving state of step S304, electric power is smaller than that in the normal operation state, and electric power is supplied to limited circuit elements included in the main controller 101. As described above, the power source device 219 enables only the small power source circuit and supplies limited electric power to the power-saving circuit element 241 and the USB I/F 227 included in the main controller 101. In this embodiment, an upper limit of total electric power supplied to the small power source circuit in the power saving state is 10 W, and upper limits of electric power supplied to the interfaces and the circuit elements are described in an electric power upper limit table 400 illustrated in FIG. 4. For example, an electric power upper limit of the USB I/F 227 is 7 W, that is, a USB device corresponding to power consumption equal to or smaller than 7 W is connectable to the USB I/F 227.

In the power saving state, a return factor causing a return to the normal operation state is detected in step S305.

Here, as the return factor, the operation unit I/F 206 detects pressing of the switch included in the operation unit 102 or the LAN I/F 208 detects reception of a print job, for example. Alternatively, a return factor is detected when a return operation performed by a USB device connected to the USB I/F 227 is detected by the USB I/F controller 229.

Each of the interfaces which have detected the return factor notifies the power source controller 218 of the return factor through the return control line 223 or 226, and the process of transferring from the power saving state to the normal operation state is performed (S306). Here, the power source controller 218 performs control so that the large power source circuit of the power source device 219 becomes available and supply of electric power to the power supply line 221 becomes available. In this way, the normal-operation circuit element 240 is powered. Furthermore, the power supply line 225 connected to the USB I/F 227 is switched from the small power source circuit to the large power source circuit. After the return process of the CPU 201 and the circuit elements included in the main controller 101 is terminated, the process returns to step S301, that is, the normal operation state is entered again.

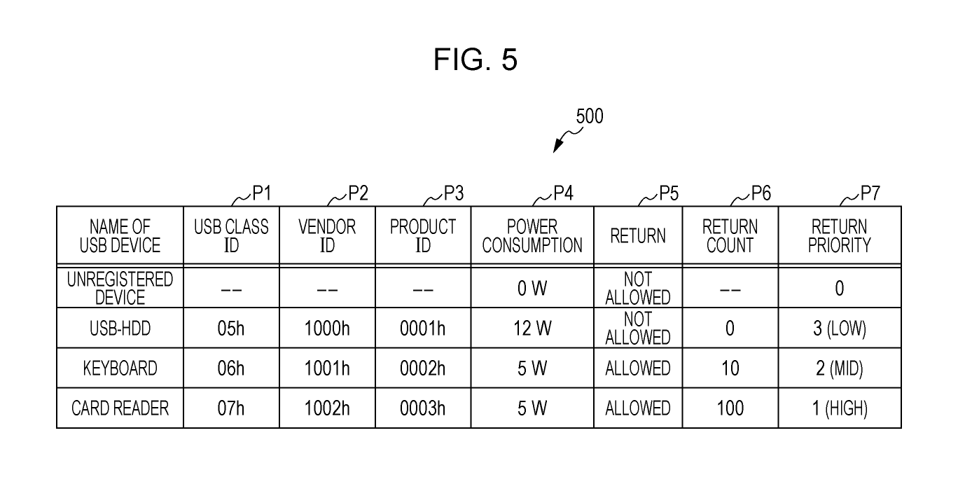

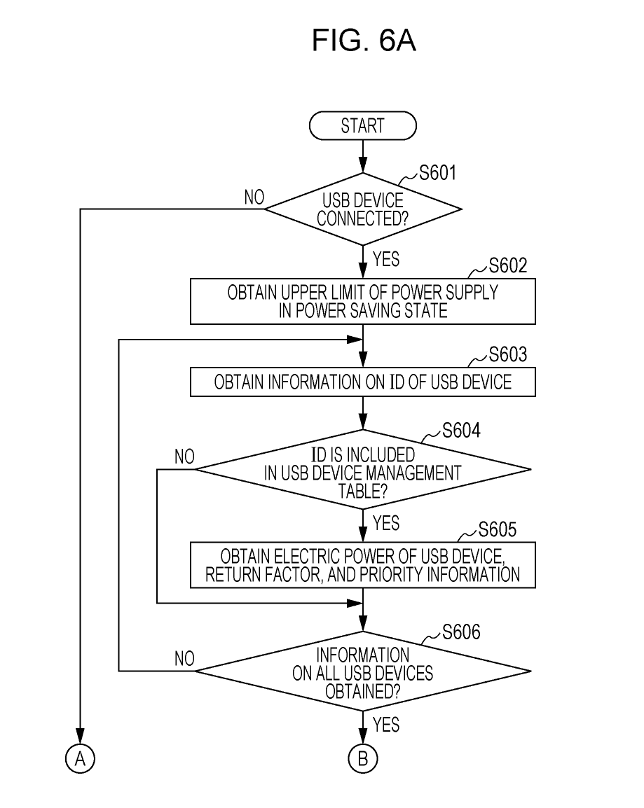

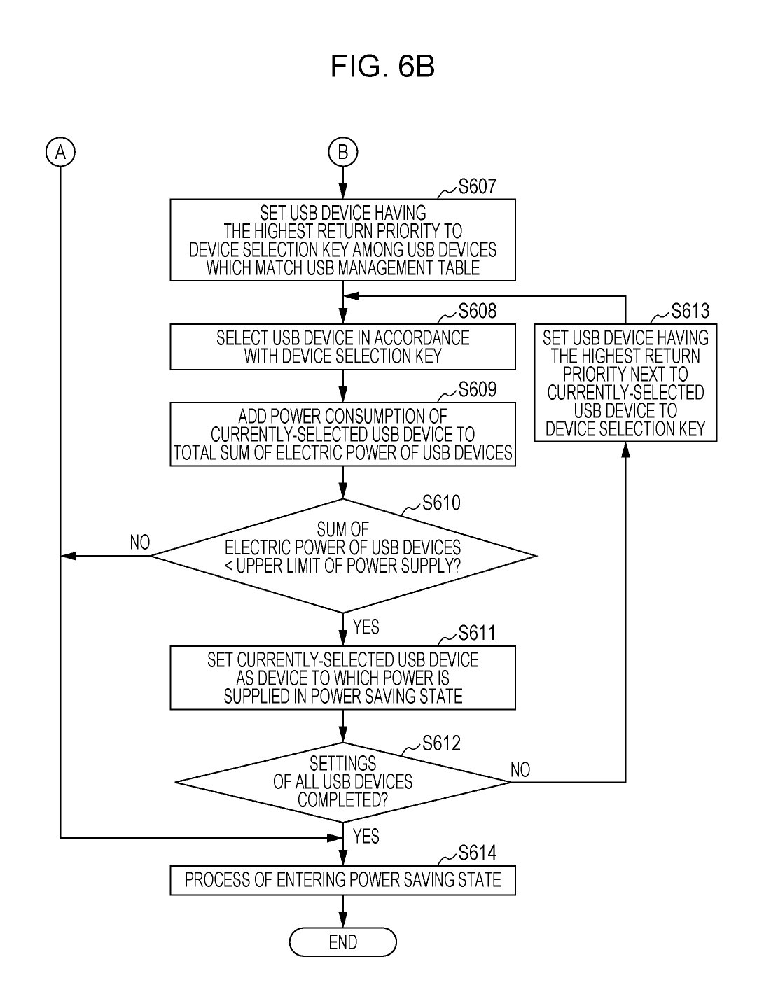

Next, a control process of selecting a USB device to be enabled by supplying electric power in the power saving state which is performed by the USB I/F 227 will be described with reference to FIGS. 5 and 6.

FIG. 5 is a diagram illustrating an exemplary USB device management table which manages the USB devices connected to the USB I/F 227 illustrated in FIG. 2.

In this example, various ID values (ID P1 to ID P3) serving as identification information, a power consumption value P4, information whether an operation of a corresponding USB device serves as a return factor P5, the number of times P6 a corresponding USB device is used for return, and a return priority P7 determined in accordance with the number of time a corresponding USB device is used for return are associated with one another in a USB device management table 500. The USB device management table 500 is stored in the flash memory 204 in advance and is developed in the RAM 202 by the CPU 201 so that the CPU 201 refers to the USB device management table 500 after the data processing apparatus 100 is activated.

In general, a USB device has device information unique to the device. The USB devices connected to the USB I/F 227 may be uniquely determined by obtaining information on the connected USB devices and comparing the device information with values included in the USB device management table 500. In this embodiment, as illustrated in FIG. 5, the determination of the connected USB devices is performed using a class ID (ID P1) serving as driver identification information, a vendor ID (ID P2) serving as information of a manufacturer, and a product ID (ID P3) serving as device identification information uniquely assigned according to the vendor ID.

The power consumption value (P4) represents an amount of electric power supplied from the USB I/F 227 to the USB devices so that the USB devices are operated. For example, in order to simultaneously operate the card reader 231 and the keyboard 232, electric power of 10 W (=5+5 W) is required to be supplied from the USB I/F 227. The power consumption value (P4) represents power consumption information obtained from the connected USB devices.

Furthermore, the USB device management table 500 includes information on a return factor (P5) representing whether an operation of a corresponding USB device performed by a user serves as a return factor for return from the power saving state to the normal operation state of the data processing apparatus 100. In this embodiment, operations of the card reader 231 and the keyboard 232 serve as return factors which enable return and an operation of the USB-HDD 233 does not serve as a return factor. For example, a return factor is generated when the USB I/F 227 detects a press of a key of the keyboard 232 and a notification of the generation of the return factor is supplied to the power source controller 218 through the return control line 226 so that return to the normal operation state is allowed.

Furthermore, the USB device management table 500 includes the return count P6 representing the number of times a corresponding USB device is used as a return factor. For example, in this embodiment, a return count of the keyboard 232 is 10, a return count of the card reader 231 is 100, and a return count of the USB-HDD 233 is 0. A return priority P7 is determined in accordance with the number of times a corresponding USB device is used as a return factor which is represented by the return count P6. The return priority P7 is assigned to the USB devices such that 1 to N (N is a natural number) are assigned to the USB devices in ascending order starting from a USB device having the largest return count, and “0” is assigned to a USB device to which the return priority P7 is not assigned. In this embodiment, “1” is assigned to the card reader 231, “2” is assigned to the keyboard 232, and “3” is assigned to the USB-HDD 233.

To a USB device which has not been registered in the USB device management table 500, that is, a USB device which is connected to the USB I/F 227 but which does not match the device information included in the USB device management table 500, 0 W is assigned to the power consumption P4, “not allowed” is assigned to the return factor P5, and “0” is assigned to the return priority P7.

FIGS. 6A and 6B are a flowchart illustrating a method for controlling the data processing apparatus 100 of this embodiment. A process of controlling power supply to the USB devices connected to the USB I/F 227 which is performed by the USB I/F 227 of FIG. 2 at a time of transfer to the power saving state is illustrated. This flowchart is started when the CPU 201 detects start of the process of transfer from the normal operation state to the power saving state of the data processing apparatus 100 (S303) and issues an instruction to the USB I/F 227.

In the power saving state transfer process of the data processing apparatus 100, the USB I/F 227 determines whether a USB device is connected (S601). Specifically, the USB I/F 227 determines whether a USB device is connected in accordance with a result of detection of a voltage variation of a power source line (VBus) of a USB terminal generated when a USB device (USB cable) is connected which is stored in the USB I/F controller 229 included in the USB I/F 227. In this embodiment, the USB I/F controller 229 detects connections of the USB devices, that is, the card reader 231, the keyboard 232, and the USB-HDD 233.

When the USB I/F 227 determines that any USB device is not connected in step S601, the processing flow is terminated. On the other hand, when determining that a USB device is connected, the USB I/F 227 obtains an upper limit of electric power to be supplied to USB devices in the power saving state (S602). Specifically, an amount of electric power to be supplied to the USB I/F 227 obtained by the CPU 201 with reference to the power saving state power supply table is set in a register, not illustrated, of the USB I/F 227. In this embodiment, the upper limit of power supply to the USB I/F 227 is 7 W.

Next, ID information (a class ID (P1), a vendor ID (P2), and a product ID (P3)) of the connected USB device are obtained (S603).

Specifically, the CPU 201 obtains ID information through a device driver corresponding to the device connected to the USB I/F 227. Thereafter, it is determined whether the obtained ID information is included in the USB device management table 500 by comparing the ID information with the USB device management table 500 (S604).

When determining that the obtained ID information matches the ID information stored in the USB device management table 500, the CPU 201 obtains electric power information, return factor information, and priority information of the matched USB device from the USB device management table 500 (S605). Subsequently, the CPU 201 performs the process from step S603 to step S605 the number of times corresponding to the number of USB devices connected to the USB I/F 227 (S606).

In this embodiment, the card reader 231, the keyboard 232, and the USB-HDD 233 which are connected as the USB devices have all been registered in the USB device management table 500, and therefore, an unregistered device does not exist. Accordingly, the process from step S603 to step S605 is performed three times in total so that power consumptions, the return counts, and the return priorities of the USB devices connected to the USB I/F 227 are obtained.

After the ID information for specifying types of all the connected USB devices is obtained, the CPU 201 selects a USB device to be operated in the power saving state from among the USB devices which match the USB device management table 500 (S607 to S613).

First, the CPU 201 sets the highest return priority P7 selected from among the return priorities P7 of the USB devices which match the USB device management table 500 as a search key (that is, a device selection key) (S607). The USB device management table 500 may be scanned using the device selection key. In this embodiment, the highest return priority P7 (value=1) is set as the device selection key.

Next, the CPU 201 selects one of the USB devices in accordance with the device selection key (S608). In this embodiment, a value of the return priority P7 of the card reader 231, that is, 1, is set as the device selection key.

Furthermore, a power consumption value of the selected USB device is obtained and is added to a sum of electric power of USB devices serving as a temporal value (S609). In this embodiment, a power consumption value of the card reader 231 is 5 W, and here, the sum of electric power of USB devices is 5 W.

Thereafter, a total sum of the electric power of USB devices and the upper limit of the electric power (7 W) available for USB devices in the power saving state which is obtained in step S602 are compared with each other (S610). When it is determined that the total sum of the electric power of USB devices is equal to or smaller than the upper limit of the available electric power in step S610, the USB device currently selected is set as a device to which the electric power is to be supplied in the power saving state (S611). The process from step S608 to step S611 described above is performed on all the USB devices connected to the USB I/F 227 (S612).

Here, when the process is performed on the next USB device (No in step S612), the highest priority next to the priority of the USB device currently selected is set as the device selection key (S613) and the process from step S608 to step S611 is performed again. When the total sum of electric power of USB devices exceeds the upper limit of available electric power, the process proceeds to step S614 described below.

In this embodiment, the total sum of electric power of USB devices is 5 W when the card reader 231 is first selected. Since the total sum is smaller than the upper limit of available electric power of 7 W, a result of the determination of step S610 represents true. Therefore, the card reader 231 is set as a device to which electric power is to be supplied in the power saving state (S611). Since still another USB device to be processed exists, the process proceeds to step S613 where a value of a return priority of the keyboard 232, that is, 2, is set as the device selection key. The keyboard 232 is selected as the USB device in accordance with the device selection key (S608), and thereafter, power consumption (5 W) of the keyboard 232 is obtained in step S609. Subsequently, the power consumption (5 W) of the keyboard 232 is added to the total sum of electric power of USB devices (5+5=10 W) in step S609 and a resultant value is compared with the upper limit of available electric power in step S610. Here, since the total sum of electric power of USB devices (10 W) exceeds the total sum of electric power of USB devices, the process proceeds to step S614.

After the USB device to which the electric power is to be supplied in the power saving state is determined, the USB I/F 227 performs the process of transferring to the power saving state (S614). The USB power source controller 228 included in the USB I/F 227 allocates electric power supplied from the power source controller 218 through the power supply line 225 only to the USB devices which are determined in advance as devices to which the electric power is to be supplied in the power saving state.

Meanwhile, to a USB device which is set as a device to which the electric power is supplied in the normal operation state but is not supplied in the power saving state, supply of the electric power is stopped. In this embodiment, electric power is supplied to the card reader 231 but supply of the electric power to the keyboard 232 and the USB-HDD 233 is stopped. Thereafter, the power saving state is entered and the processing flow is terminated.

The setting of the available USB device to which the electric power is supplied in the power saving state determined in the processing flow described in FIGS. 6A and 6B may be confirmed using the operation unit 102 after return to the normal operation state is performed.

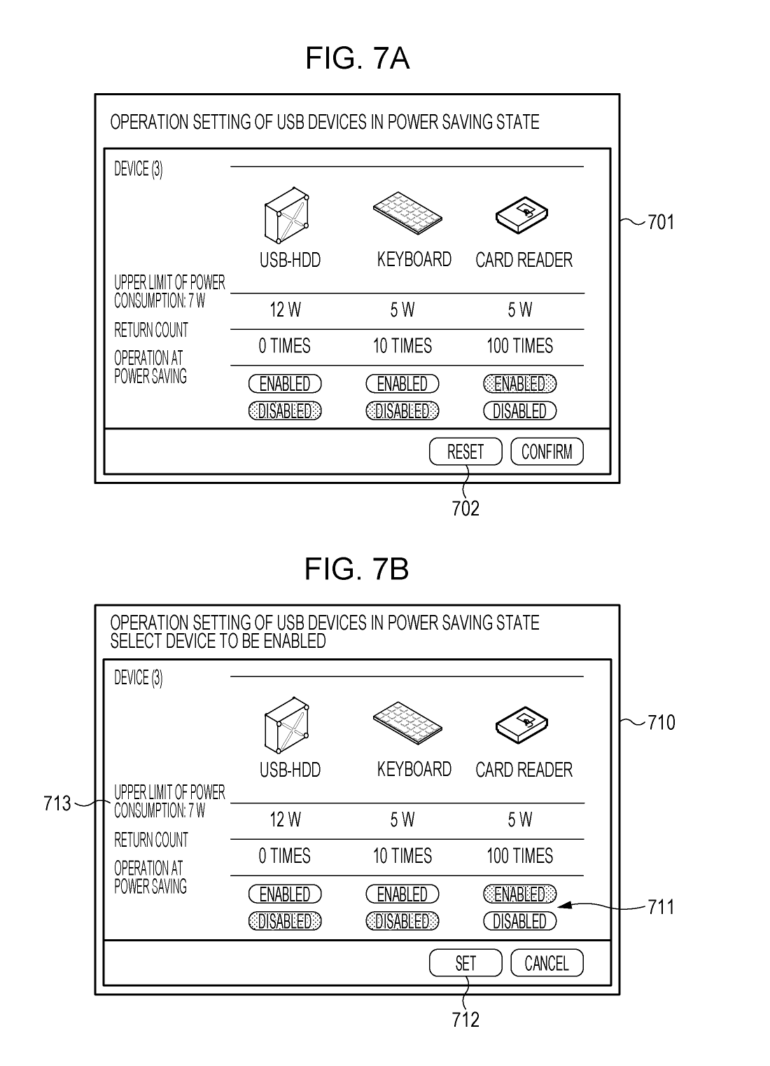

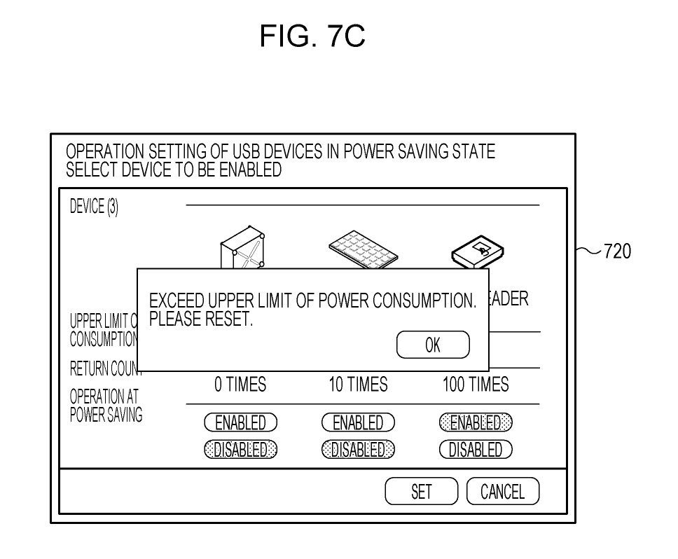

FIGS. 7A to 7C are diagrams illustrating exemplary UI screens displayed in the operation unit 102 illustrated in FIG. 1. In this examples, screens for setting operations of the USB devices in the power saving state which are displayed in a liquid crystal touch panel, not illustrated, included in the operation unit 102 are illustrated. These screens are displayed when the user performs a predetermined menu operation, not illustrated, in the normal operation state of the data processing apparatus 100.

The USB devices connected to the USB I/F 227 are displayed in the screens, and furthermore, the power consumption, the return count representing the number of times a corresponding device is used for return from the power saving state, and operation enabling or operation disabling in the power saving state which is determined in the processing flow described above with reference to FIGS. 6A and 6B are displayed for each USB device.

In this embodiment, the card reader 231 is set to be enabled and the keyboard 232 and the USB-HDD 233 are set to be disabled.

If the user intentionally changes a setting, a resetting button 702 is pressed in a screen 701 (FIG. 7A) and buttons 711 are pressed in a screen 710 (FIG. 7B). In this way, desired USB devices are set enabled and the others are set disabled, and thereafter, the setting button 712 is pressed. Here, the USB devices to be enabled are set so that a total amount of power consumption of the USB devices to be enabled is equal to or smaller than a power consumption upper limit 713. In this embodiment, selection may be made until a total amount of power consumption of 7 W is reached.

When the total amount of power consumption of the USB devices set to be enabled is larger than the power consumption upper limit, the CPU 201 displays a screen 720 which prompts re-instruction in the operation unit 102 as illustrated in FIG. 7C.

As described above, the USB I/F 227 determines connected USB devices and obtains return priorities of the USB devices in accordance with amounts of power consumption of the USB devices and the number of times the USB devices are used for return from the power saving state before the data processing apparatus 100 enters the power saving state.

Furthermore, USB devices which are frequently used and which serve as return factors may be enabled while the upper limit of supplied electric power is satisfied in the power saving state, and in addition, the user may change settings where appropriate. As a result, power saving is realized while convenience of return to the normal operation state from the power saving state is ensured.

The processes may be realized by executing software (programs) obtained through a network or various storage media by a processing device (such as a CPU or a processor) of a personal computer or the like.

The disclosure is not limited to the foregoing embodiments and various modifications (including organic combinations of the embodiments) may be made within the scope of the disclosure and the modifications are not excepted from the scope of the disclosure.

According to one aspect of the embodiments, after the power saving mode is entered, a peripheral device having high priority for detecting a return factor is specified and electric power is supplied to the device within an amount of available electric power.

### Other Embodiments

Embodiments of the disclosure may also be realized by a computer of a system or apparatus that reads out and executes computer executable instructions recorded on a storage medium (e.g., non-transitory computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2012-266915, filed Dec. 6, 2012, which is hereby incorporated by reference herein in its entirety.

What is claimed is:

1. A data processing apparatus operating in a first power mode and a second power mode in which power consumption is lower than that of the first power mode, the data processing apparatus comprising:
a plurality of USB interfaces;
a selection unit configured to select at least one of the USB interfaces which is to be used when the second power mode is entered; and
a control unit configured to perform control so that, in the second power mode, electric power is supplied to a device connected to the at least one of the USB interfaces selected by the selection unit through the selected at least one of the USB interfaces,
wherein electric power is not supplied from the data processing apparatus to devices connected to the USB interfaces which are not selected by the selection unit.

2. The data processing apparatus according to claim 2,
wherein the USB interfaces conform with the USB 3.0 standard.

3. The data processing apparatus according to claim 1 further comprising:
an obtaining unit configured to obtain identification information of devices connected to the USB interfaces from the devices,
wherein the selection unit selects at least one of the USB interfaces to which electric power is to be supplied in the second power mode in accordance with the identification information obtained by the obtaining unit.

4. The data processing apparatus according to claim 1 further comprising:
an obtaining unit configured to obtain power consumption of devices connected to the USB interfaces from the devices,
wherein the selection unit selects at least one of the USB interfaces to which electric power is to be supplied when the second power mode is entered in accordance with the power consumption of devices obtained by the obtaining unit.

5. The data processing apparatus according to claim 4,
wherein the selection unit selects at least one of the USB interfaces to which electric power is to be supplied in the second power mode in accordance with a limit value of electric power to be supplied in the second power mode and the information on power consumption of the devices obtained by the obtaining unit.

6. A method for controlling a data processing apparatus which has a plurality of USB interfaces and which operates in a first power mode and a second power mode in which power consumption is lower than that of the first power mode, the method comprising:
selecting at least one of the USB interfaces which is to be used when the second power mode is entered; and
supplying, in the second power mode, electric power to a device connected to the selected at least one of the USB interfaces through the selected at least one of the USB interfaces.

7. A program which causes a computer which controls a data processing apparatus which has a plurality of USB interfaces and which operates in a first power mode and a second power mode in which power consumption is lower than that of the first power mode to function as:
a selection unit configured to select at least one of the USB interfaces which is to be used when the second power mode is entered; and
a control unit configured to perform control so that, in the second power mode, electric power is supplied to a device connected to the at least one of the USB interfaces selected by the selection unit through the selected at least one of the USB interfaces.
